(19) United States
(12) Patent Application Publication
(10) Pub. No.: US 2015/0028138 A1
(43) Pub. Date: Jan. 29, 2015

(54) Coating Thickness and Distribution Control Wiping Nozzle with Excellent Pressure Uniformity

(71) Applicant: Cockerill Maintenance & Ingénierie S.A., Seraing (BE)

(72) Inventor: Michel Dubois, Boncelles (BE)

(73) Assignee: Cockerill Maintenance & Ingenierie S.A., Seraing (BE)

(21) Appl. No.: 14/379,988

(22) PCT Filed: Feb. 13, 2013
(86) PCT No.: PCT/EP2013/052891

§ 371 Date: Aug. 20, 2014

(30) Foreign Application Priority Data
Feb. 21, 2012 (EP) 12156296.1

(51) Int. Cl. B05C 11/06; B05B 1/00

(52) U.S. Cl. CPC B05C 11/06; B05B 1/005
USPC 239/597

(57) ABSTRACT

The present invention relates to a device for controlling the thickness of a coating made of a liquid film on a moving strip (3), comprising a nozzle (1) fed with a pressurized fluid (6) in a chamber (2) of the nozzle, said chamber (2) being terminated by nozzle lips (11) making an elongated discharge opening (12) for discharging the pressurized fluid onto the moving strip (3), said chamber (2) comprising also a perforated baffle plate (8) obstructing a cross-section L×h of the chamber (2) in the fluid flow, the perforated baffle plate (8) having a number of holes (13) so that the total surface of said holes (13) is higher than 90% of said cross-section and having a thickness Th higher than 3 times the individual diameter of any of said holes (13) and higher than 3 mm, characterised in that the perforated baffle plate (8) has a honeycomb geometry, i.e. a geometry having cells (13) with hexagonal section.

### FIELD OF THE INVENTION

The present invention relates to a gas wiping device for controlling the thickness of a liquid film on a running strip. A typical example is a device intended for gas wiping of a liquid metal on wide coated steel sheets, such as those obtained by hot dip coating.

### GENERAL BACKGROUND AND PRIOR ART

In hot dip coating, coating uniformity of coated sheets is a main concern.

When an air knife system is used, it is well known that obtaining uniformity requires a uniform running speed, a constant nozzle-to-strip distance and a uniform gas flow at the exit of the nozzle. Any variation in those operating parameters will result in coating thickness variations.

The devices in the frame of the present invention are concerned with obtaining a uniform gas flow all along a thin opening such as a slit which has a typical length of 2.5 meters and an opening thickness of 0.5 to 2 mm. FIG. 1 is a cross-section view of a typical nozzle design used in the hot dip coating industry. The nozzle 1 is located in front of the running coated sheet 3 coming out of the coating bath containing the liquid metal. The exit of the nozzle is made of inclined lips 11 which define an extended longitudinal opening or slit 12. FIG. 2 is a corresponding front view of the strip 3 and the device of FIG. 1.

First, experience has shown that the angle 10 between the strip 3 and the nozzle faces oriented towards the strip 3 must be wide in order to reduce the vortex and recirculation created by high gas flow. In this regard FIG. 5 shows a typical vortex configuration developing when angle 10 is small.

Thus, because of the usually reduced available space, the dimensions of the chamber 2, especially its length 4 and height 5 are quite limited (see FIG. 1 and FIG. 2).

Air supply 6 provided to the device can be obtained by different known methods, for example with injection either from the top (FIG. 1), from the side (FIG. 2) or from the back. This air supply 6 must be flexible because the device is usually moved in operation according to the specific process window. A typical displacement length of the device can reach up to 100 mm. Therefore, the pipes used must have special diameter-length ratio to accommodate this displacement without detrimental effect on their life time.

In addition, the diameter of the feeding pipe 6 as well as the chamber cross-section cannot be too small because otherwise the gas velocity in the pipe becomes too high leading to variation of the gas flow along the opening which further gives non-uniform coating thickness. FIG. 3 shows an example of gas flow and results obtained from an investigation done by the inventor when the design ratios are not correctly selected, actually in the case when air is supplied through four top openings 6. FIG. 6 shows, in another example, the flow and exit velocity along the nozzle in case of a single (or asymmetric) side gas inlet 6.

Above-mentioned problems are quite well-known in the industry and some technical solutions have already been proposed like that described in U.S. Pat. No. 4,041,895.

This document discloses a system for controlling the thickness and distribution of a coating applied to a moving substrate, including a pair of “air knives” which discharge pressurized fluid onto a moving substrate as it emerges from a coating bath to screed excess coating from the substrate and leave a coating deposit having a desired thickness and distribution. Each air knife has a plenum chamber which supplies pressurized fluid to a pair of nozzle lips that define an elongated nozzle opening. Fluid flow influencing devices are provided between the plenum and the nozzle lips of each air knife, preferably including a baffle plate, a screen assembly, a shutter plate, and a vane assembly. The baffle plate and the screen assembly help assure that a laminar, equally pressurized flow is supplied to the shutter plate. The shutter plate has specially configured flow restricting openings that cause the pressure profile of fluid discharging from the air knives to vary in a predetermined manner along the length of their nozzle openings, whereby coating profiles are caused to vary in a predetermined manner across the width of the substrate. The vane assembly includes vanes which help to control the directions of fluid discharge through the nozzle openings. Pressurized fluid is supplied to the air knives by a system which includes a blower, and blower speed is controlled in response to sensed line speed of the moving substrate to assure that a coating deposit of desired thickness remains on the substrate.

Thus the above-mentioned solutions usually consist either in baffles installed within the chamber, or alternately in plates 7 (see for example FIG. 1) provided with a number of holes whose purpose is to uniformize the pressure downstream of the plate by generating a quite high pressure drop.

These prior art solutions have however two main drawbacks:
they cost a significant amount of energy due to the pressure drop;
they are not able to suppress the vortex developed inside the chamber due to fact that the design cannot reduce the fluid velocities in the directions other that perpendicular to the baffle plate. The vortices are also responsible of non-uniform gas flow along the opening because of higher localized total pressure when the vortex collides. An example of such internal vortex due to inlet pipes is shown on FIG. 3. Additionally FIG. 4 shows the corresponding computed velocities across the exit along the nozzle length and width. The different lines correspond to the corresponding velocities at the different locations across the opening thickness, the higher values corresponding so to the center of the opening and the lower ones to those closer to the opening walls.

Document JP 08 319 551 A discloses a gas wiping nozzle for blowing gas onto the surface of a steel strip continuously lifted up out of a molten metal plating tank, and controlling the thickness of adhering metal. The gas wiping nozzle comprises a gas inlet, a multi-orifice block, a first pressure-equalizing chamber, a narrowed part, a second pressure-equalizing chamber, and a gas outlet in the form of a slit, in the stated order, the narrowed part being offset from a centre line of the slit in order to bend a flow path. The multi-orifice block has an orifice-opening ratio of at least 20%. The equivalent diameter of the orifices does not exceed 10 times the gap of the slit, and the first pressure-equalizing chamber has a flow path length of at least six times the diameter of the orifices in the multi-orifice block.

### Aims of the Invention

The present invention aims at avoiding the drawbacks of prior art.

In particular, the invention aims at uniformizing the total pressure in the chamber by suppressing the internal vortex in the nozzle chamber as well as significantly improving the static gas pressure uniformity. As a result a much higher uniformity of the exit velocity is to be obtained along the nozzle opening.

Another goal of the invention is to limit the pressure drop in the nozzle chamber owing to the presence of a perforated plate baffle.

### SUMMARY OF THE INVENTION

The present invention relates to a device for controlling the thickness of a coating made of a liquid film on a moving strip, comprising a nozzle fed with a pressurized fluid in a chamber of the nozzle, said chamber being terminated by nozzle lips making an elongated discharge opening for discharging the pressurized fluid onto the moving strip, said chamber comprising also a perforated baffle plate obstructing a cross-section L×h of the chamber in the fluid flow, the perforated baffle plate having a number of holes so that the total surface of said holes is higher than 90% of said cross-section and having a thickness Th higher than 3 times the individual diameter of any of said holes and higher than 3 mm, characterised in that the perforated baffle plate has a honeycomb geometry, i.e. a geometry having cells with hexagonal section.

According to a preferred embodiment, the elongated discharge opening of the nozzle is a slit having a length up to 2.5 meters and a thickness up to 3 mm.

The device of the present invention is particularly intended to be used in the following conditions:
the moving strip is a sheet coated with a liquid, emerging from a coating bath;
the moving strip is a metal sheet coated with a metal liquid, emerging from a hot dip coating bath;
the hot dip coating bath is a galvanization bath for steel sheets;
the pressurized fluid is a pressurized gas;
the pressurized gas comprises a mixture of oxygen and nitrogen.

### SHORT DESCRIPTION OF THE DRAWINGS

FIG. 1 schematically represents a cross-section of a typical nozzle for gas wiping of a coated sheet, provided with a perforated plate in the nozzle chamber, according to prior art.

FIG. 2 schematically represents a front view of the nozzle and sheet of FIG. 1.

FIG. 3 shows the computed gas flow for a nozzle fed with gas through four top circular openings.

FIG. 4 shows the exit velocity computed for the nozzle simulated in FIG. 3. The different lines correspond to the velocity across the height of the nozzle opening.

FIG. 5 shows the typical high vorticity especially obtained when the angle between the strip and the nozzle end is closed.

FIG. 6 displays in the upper part the flow inside a nozzle chamber when it is supplied with only a side inlet, the bottom part showing the corresponding computed exit velocity.

FIG. 7 schematically represents a nozzle provided with a so-called honeycomb device according to the present invention.

FIG. 8 is a cross-section of a typical embodiment of the invention.

FIG. 9 is a perspective view of an industrial embodiment corresponding to FIG. 8.

FIG. 10 shows the uniform pressure profile at the exit of the nozzle, obtained by the device of the invention, the bottom numbers referring to the position of each particular gas inlet pipe along the opening of the nozzle.

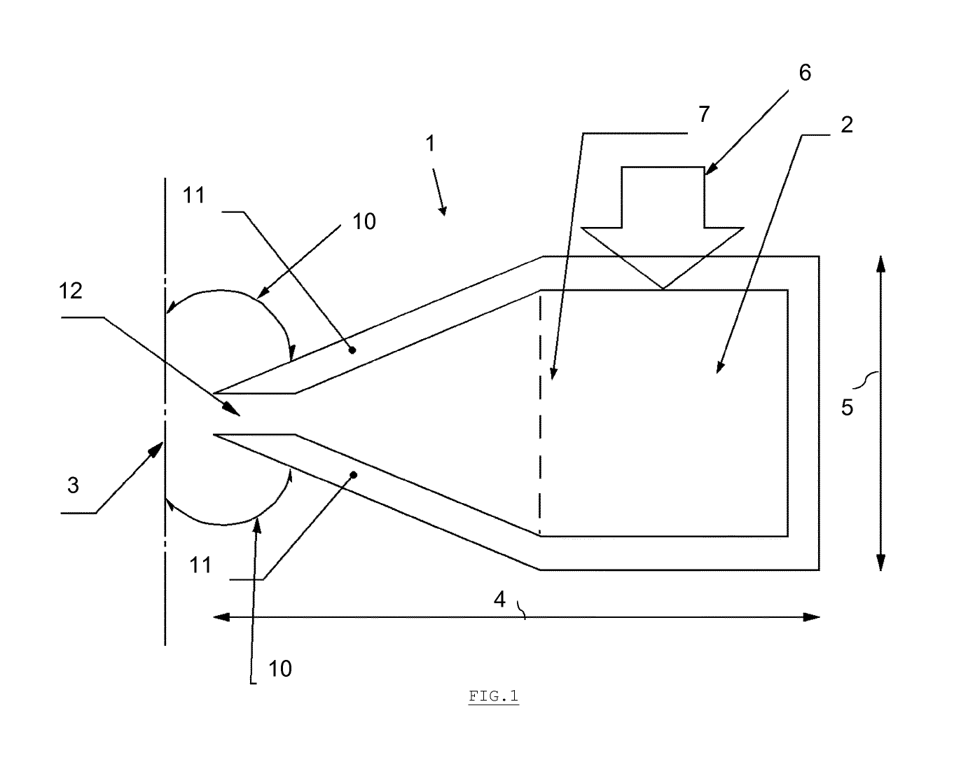

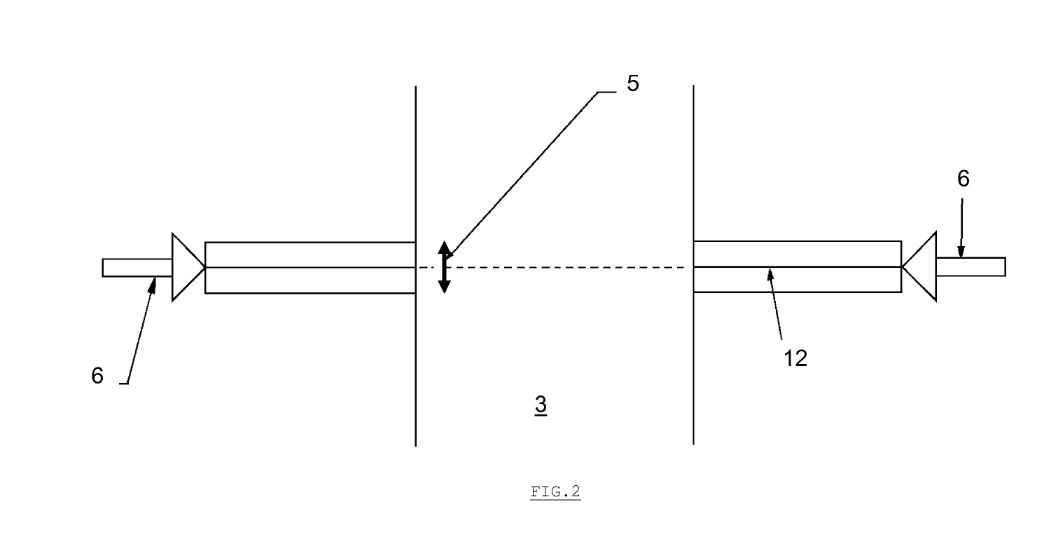

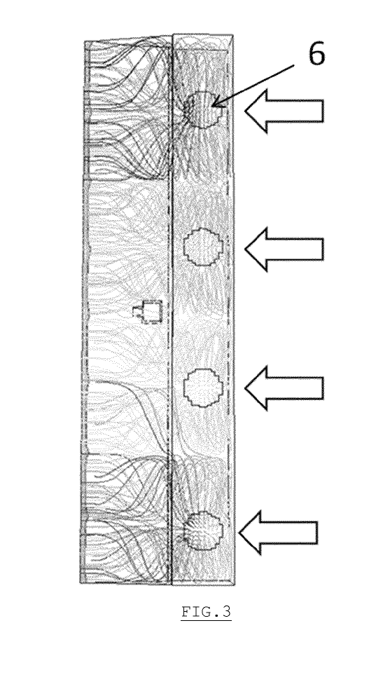

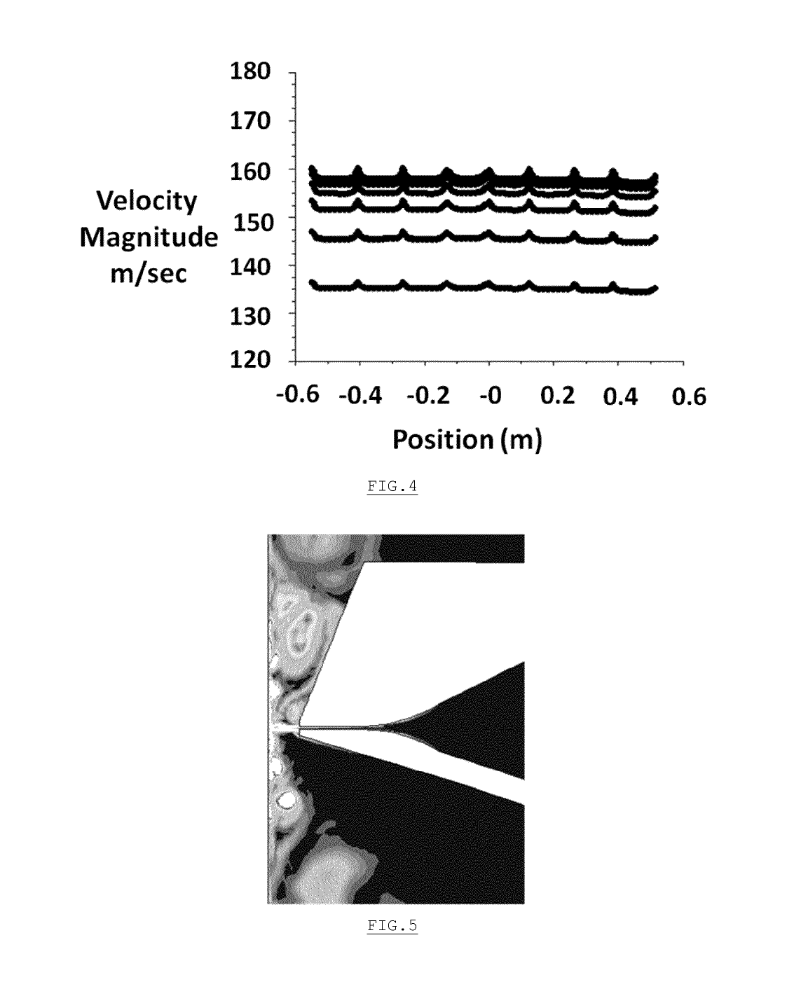

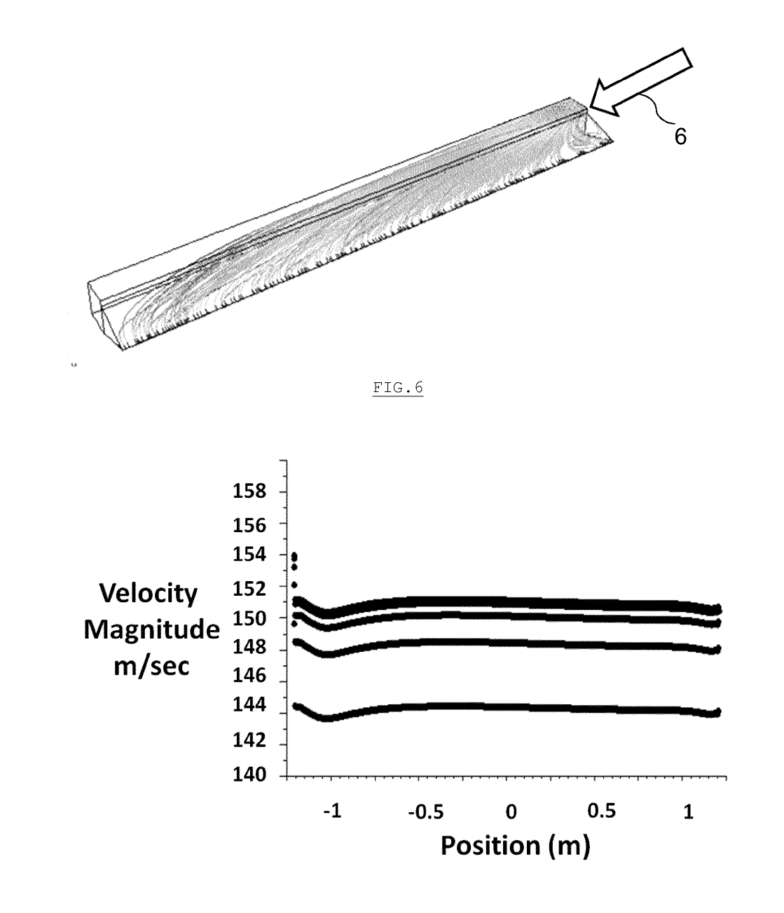

### DETAILED DESCRIPTION OF THE INVENTION AND PREFERRED EMBODIMENTS

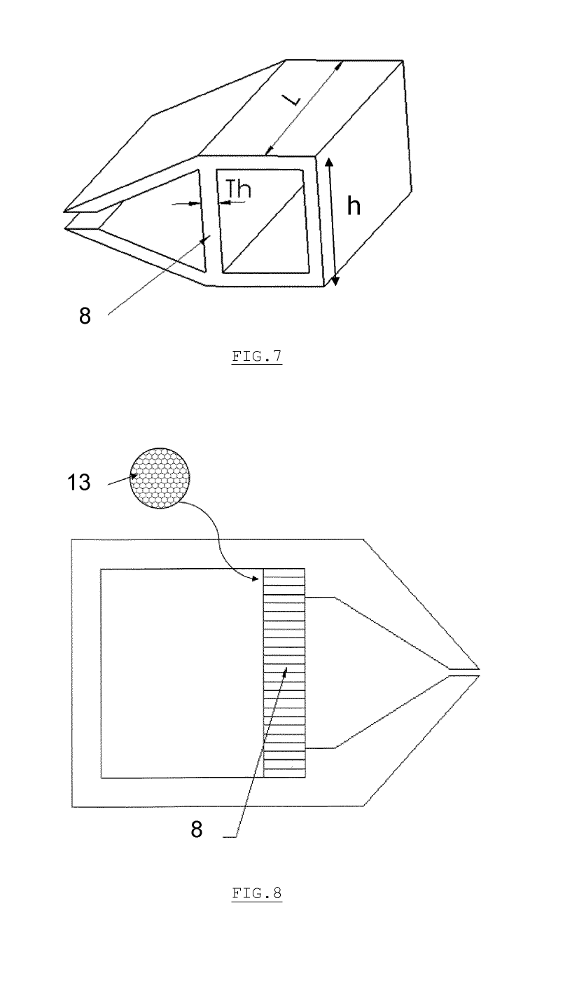

According to a first preferred embodiment, the invention concerns an implementation, inside the nozzle chamber and inside the gas flow, of a particular component provided with holes, hereinafter called “honeycomb” geometry component, as schematically shown in FIG. 8. In principle, the honeycomb geometry refers to a structure having void cells 13 of hexagonal section. In this case the so-called diameter of the cell is the diameter of the circumcircle of the hexagon. However it will be under the scope of the present invention to admit hole structures departing from the “ideal” hexagonal model.

As a perforated plate baffle is used, causing pressure drop in the nozzle chamber, the invention improves the situation by seeking a void ratio, i.e. the sum of hole sections divided by the total cross-section of the plate, close to one.

According to the invention this part 8 is however characterized by the following features:
a plate with a high number of holes. The total surface of the holes has to be higher than 90% of the total cross-section (L×h), as represented in FIG. 7;
a thickness of the component (Th) higher than 3 times the individual hole diameter and being higher than 3 mm.

It was observed that the device of the invention has the property to block the internal gas vortex and to orient the fluid flow in the proper direction, i.e. the direction in which it has to be at the exit of the nozzle. This is obtained with a minimum loss of energy which means that the system does not in principle require increasing the pressure capacity of the blowers usually used to produce the fluid under pressure. Using the device of the invention, the diameter of the pipes feeding the chamber can advantageously be reduced.

As a consequence of the invention, the use of a thin internal baffle plate 7, as described for example in U.S. Pat. No. 4,041,895, is not necessary anymore.

### EXAMPLE

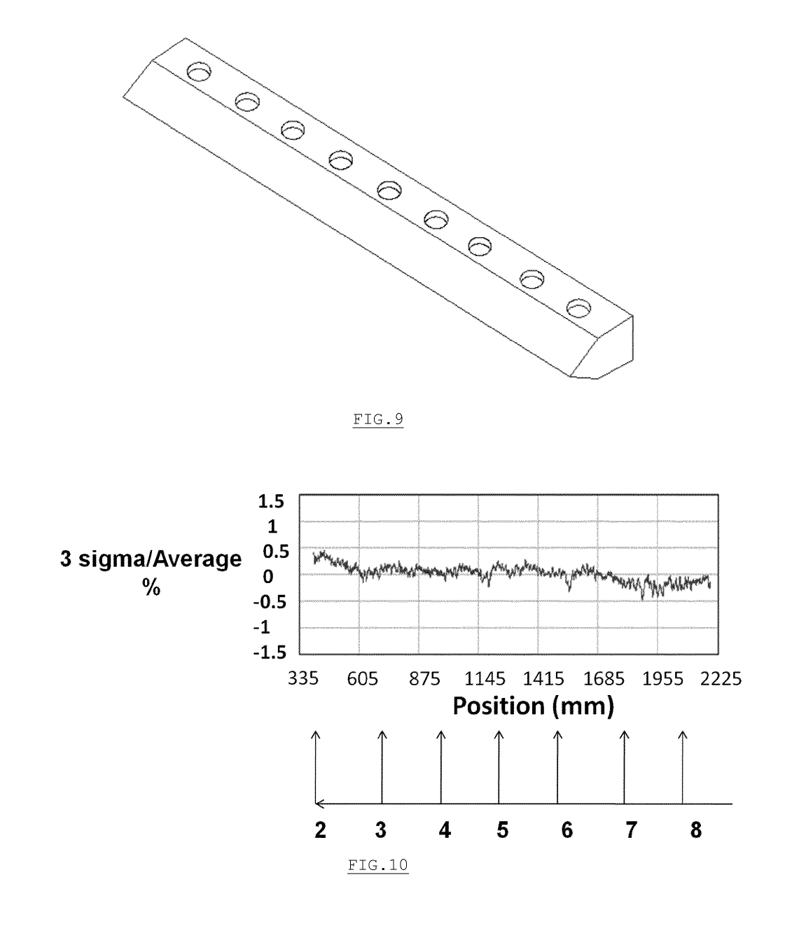

FIG. 9 shows an example of industrial realization according to the invention.

The efficiency of the device has been checked by measuring the dynamic pressure all along the nozzle by a Pitot tube. According to FIG. 10, one can observe a good or satisfactory pressure uniformity measured in % of the average, all along the opening in this particular device. The experiments have shown that the variations from max. to min. value measured are less than about 1% for a nozzle being 2 meter long and having an opening of less than 2 mm.

The nozzle as described here is typically dedicated to the wiping of a liquid entrained by a moving strip. The liquid can be either aqueous or consist in a liquid metal. The strip considered here above may have typical width from 600 to 2300 mm.

### LIST OF REFERENCE SYMBOLS

1. nozzle

2. chamber

3. strip

4. chamber length

5. chamber height

6. air supply

7. perforated plate baffle

8. “honeycomb” component

10. nozzle end angle

11. nozzle lip

12. nozzle opening (or slit)

13. hole

1. A device for controlling the thickness of a coating made of a liquid film on a moving strip (3), comprising a nozzle (1) fed with a pressurized fluid (6) in a chamber (2) of the nozzle, said chamber (2) being terminated by nozzle lips (11) making an elongated discharge opening (12) for discharging the pressurized fluid onto the moving strip (3), said chamber (2) comprising also a perforated baffle plate (8) obstructing a cross-section L×h of the chamber (2) in the fluid flow, the perforated baffle plate (8) having a number of holes (13) so that the total surface of said holes (13) is higher than 90% of said cross-section and having a thickness Th higher than 3 times the individual diameter of any of said holes (13) and higher than 3 mm, characterised in that the perforated baffle plate (8) has a honeycomb geometry, i.e. a geometry having cells (13) with hexagonal section.

2. The device according to claim 1, characterised in that the elongated discharge opening of the nozzle (12) is a slit having a length up to 2.5 meters and a thickness up to 3 mm.
